(19) United States
(12) Patent Application Publication
(10) Pub. No.: US 2026/0340250 A1
(43) Pub. Date: Oct. 29, 2026

(54) REPORT ANALYSIS METHOD, ELECTRONIC DEVICE AND STORAGE MEDIUM

(71) Applicant: Fulian Precision Electronics (Tianjin) Co., LTD., Tianjin (CN)

(72) Inventor: Ju-Yun LEE, New Taipei (TW)

(21) Appl. No.: 19/283,663

(22) Filed: Jul. 29, 2025

(30) Foreign Application Priority Data
Apr. 23, 2025 (CN) 202510517158.4

(51) Int. Cl. G06F 30/347; G06F 119/18; G06T 7/00

(52) U.S. Cl. CPC G06F 30/347; G06T 7/0004; G06F 2119/18

(57) ABSTRACT

The present application provides a report analysis method. The method includes analyzing a report file of a printed circuit board to obtain report data, where the report data includes an identifier, problem information, and a problem image corresponding to each of at least one problem related to the printed circuit board. An identifier is received from an identifier input box, a target identifier is determined from identifiers corresponding to problems according to the received identifier. Problem information corresponding to the target identifier is determined as target problem information. Once a problem image corresponding to the target identifier is determined as the target problem image, target problem information is displayed in an information display area and the target problem image is displayed in a second area.

### TECHNICAL FIELD

The present application relates to a technical field of printed circuit board (PCB) design, and in particular to a report analysis method, an electronic device and a storage medium.

### BACKGROUND

In the field of PCB design, a cadence software, as a widely used electronic design automation tool, provides designers with powerful circuit board design functions. As a complexity of PCB design continues to increase, requirements for design quality and manufacturability are becoming increasingly stringent. Design for manufacturability (DFM) checks have become a key link to ensure a smooth transition of PCB design to a production stage.

In a PCB design process, designers usually perform a detailed PCB wiring design on a cadence allegro platform to generate allegro board file (i.e., a PCB design wiring file), which is a core file of an entire design and records all wiring, components and other key information of the circuit board. After completing a preliminary design, in order to ensure the manufacturability of the design, designers may use a professional DFM analysis tool software valor new product introduction (NPI) for inspection. The valor NPI may generate a detailed valor check report (i.e., a DFM inspection analysis report), which includes various potential manufacturing problems, such as an insufficient line width, a too small spacing, an inappropriate via size, etc.

In order to ensure that the PCB design meets requirements of a manufacturing process, designers also need to analyze the valor check report and make targeted modifications to the PCB based on an analysis result. However, designers currently usually analyze the valor check report manually, which is inconvenient. Manually finding key problems is not only time-consuming and laborious, but also cumbersome and inefficient, and prone to omissions and errors.

### BRIEF DESCRIPTION OF THE DRAWINGS

FIG. 1 is a schematic diagram of a hardware structure of an electronic device provided in an embodiment of the present application.

FIG. 2 is a flow chart of a report analysis method provided in an embodiment of the present application.

FIG. 3 is a schematic diagram of a first interface provided in an embodiment of the present application.

FIG. 4 is a schematic diagram of a second interface provided in an embodiment of the present application.

FIG. 5 is a flow chart of a report analysis method provided in yet another embodiment of the present application.

FIG. 6 is a schematic diagram of functional modules of a report analysis apparatus provided in an embodiment of the present application.

### DETAILED DESCRIPTION

The embodiments of the present application are described in detail below, and examples of the embodiments are shown in the accompanying drawings, where the same or similar reference numerals throughout represent the same or similar elements or elements having the same or similar functions. The embodiments described below with reference to the accompanying drawings are exemplary and are only used to explain the present application, and cannot be understood as limiting the present application.

In the embodiments of the present application, it should be noted that, unless otherwise clearly specified and limited, words such as “for example” are used to indicate examples, illustrations or explanations. Any embodiment or design described as “for example” in the embodiments of the present application should not be interpreted as being more preferred or more advantageous than other embodiments or designs. Specifically, the use of words such as “for example” is intended to present related concepts in a specific way.

In the description of the present application, it should be noted that, unless otherwise clearly specified and limited, the terms “installed”, “connected”, and “connected” should be understood in a broad sense, for example, it may be a fixed connection, a detachable connection, or an integral connection; it may be a mechanical connection, an electrical connection, or mutual communication; it may be a direct connection, or an indirect connection through an intermediate medium, it may be the internal connection of two elements or the interaction relationship between two elements. For ordinary technicians in this field, the specific meanings of the above terms in the present application may be understood according to specific circumstances.

In the description of the present application, it should be noted that, unless otherwise expressly specified and limited, the terms “first” and “second” are used for descriptive purposes only and cannot be understood as indicating or implying relative importance or implicitly indicating the number of technical features indicated. Therefore, the features defined as “first” and “second” may explicitly or implicitly include one or more of the features. In addition, in the description of the present application, the meaning of “a plurality of” is two or more, unless otherwise clearly and specifically limited.

In order to more clearly understand the above-mentioned purpose, features and advantages of the present application, the present application is described in detail below in conjunction with the accompanying drawings and specific embodiments. It should be noted that the embodiments of the present application and the features in the embodiments may be combined with each other without conflict.

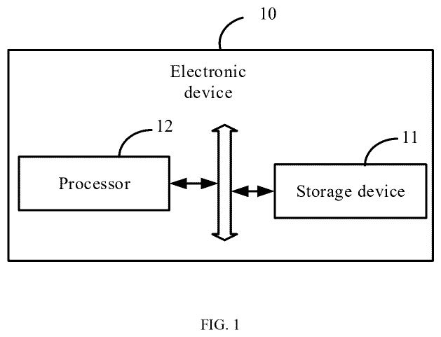

Please refer to FIG. 1, which is a schematic diagram of a hardware structure of an electronic device 10 provided in an embodiment of the present application.

Embodiments of the present application provides a report analysis method, which may be applied to one or more electronic devices 10. The electronic device 10 is a device that may automatically perform numerical calculations and/or information processing according to pre-set or stored instructions, and its hardware includes but is not limited to a microprocessor, an application specific integrated circuit (ASIC), a programmable gate array (FPGA), a digital processor (DSP), an embedded device, etc.

Specifically, the electronic device 10 is used to: analyze a report file of a printed circuit board to obtain report data, where the report data includes an identifier, problem information, and a problem image of each of at least one problem related to the printed circuit board; display a first interface including a first area and a second area, where the first area includes an identifier input box and an information display area; receive an identifier input by a user from the identifier input box, determine a target identifier from identifiers corresponding to at least one problem according to the identifier input by the user, and determine the problem information corresponding to the target identifier as target problem information, and determine the problem image corresponding to the target identifier as a target problem image; display the target problem information in the information display area, and display the target problem image in the second area.

In some embodiments of the present application, the electronic device 10 may be communicatively connected to a desktop computer, a notebook, a personal digital assistant (PDA), a cloud server, or other devices.

In some embodiments of the present application, the electronic device 10 may perform a human-computer interaction with the user through a keyboard, a mouse, a remote control, a touch pad, or a voice control device.

In some embodiments of the present application, the electronic device 10 may also include a network device and/or a client device. The network device includes but is not limited to a single network server, a server group consisting of multiple network servers, and a cloud server consisting of a large number of hosts or network servers based on cloud computing.

In some embodiments of the present application, a network where the electronic device 10 is located includes but is not limited to the Internet, a wide area network, a metropolitan area network, a local area network, a virtual private network (VPN), etc.

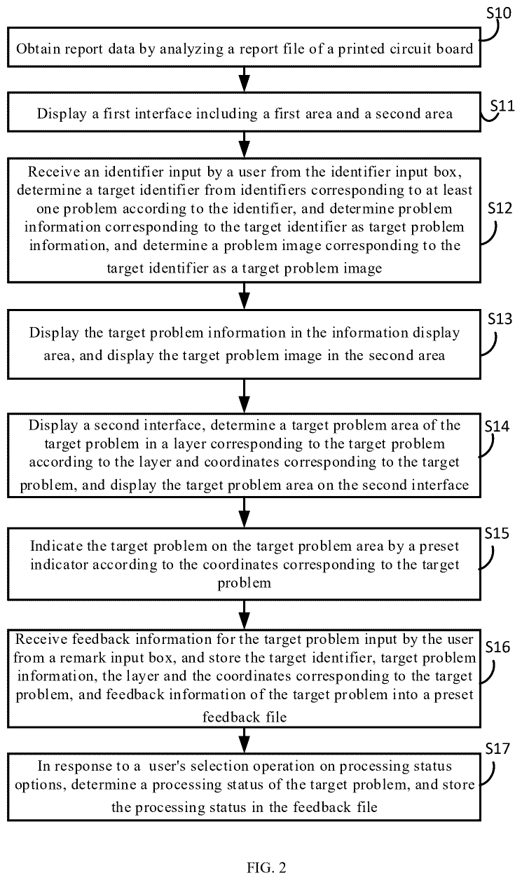

Please refer to FIG. 2, which is a schematic diagram of a flowchart of a report analysis method provided in an embodiment of the present application. The report analysis method is applied to an electronic device. Specifically, the report analysis method includes the following steps. According to different requirements, an order of some blocks in the flowchart may be changed, and some blocks may be omitted.

Block S10, the electronic device obtains report data by analyzing a report file of a printed circuit board.

In some embodiments of the present application, an automated script for automatically analyzing the report file is pre-stored in the electronic device 10. Before analyzing the report file of the printed circuit board, the electronic device 10 runs the automated script in advance and selects a report file to be analyzed. The automated script is further used to automatically read the report file to extract the report data in the report file.

It should be noted that the present application implements the function of the automated script through a SKILL language secondary developed and provided within a Cadence software. The SKILL language is a powerful programming language that may be used for simple tasks as well as for developing complex applications. It may interact with a underlying system and provides an interface to access interfaces of various tools in the Cadence software. Designers may use the SKILL language to access resources of a Cadence platform and develop automated scripts based on it. By writing a corresponding SKIL script, a function of automatically reading the report file is realized, allowing designers to load and view the report file directly in an environment of the Cadence software, thereby closely integrating a DFM analysis result with a PCB design, improving an efficiency and a quality of a design, ensuring that the design meets the production requirements in terms of manufacturability, and reducing potential problems and costs in subsequent production links.

In some embodiments of the present application, the report file of the PCB refers to a DFM inspection report generated by an audit software “Valor”, which is used to detect potential problems in the PCB design. Content included in the report file includes but is not limited to an identifier (ID), a title, a status, a priority, an image, coordinates (X, Y), a measurement value, a number of layers, a reference designator (Refdes), and a last discussion of each problem.

In some embodiments of the present application, the report data includes an identifier, problem information (such as a name, coordinates, a layer) and a problem image corresponding to each of at least one problem related to the PCB, where the problem information corresponding to each problem includes the layer and coordinates. The problemimage can be defined to be an image related to a problem. The PCB may include one or more problems. Each problem corresponds to one identifier.

Block S11, the electronic device displays a first interface including a first area and a second area.

In some embodiments of the present application, the electronic device 10 may display the first interface using an automated script.

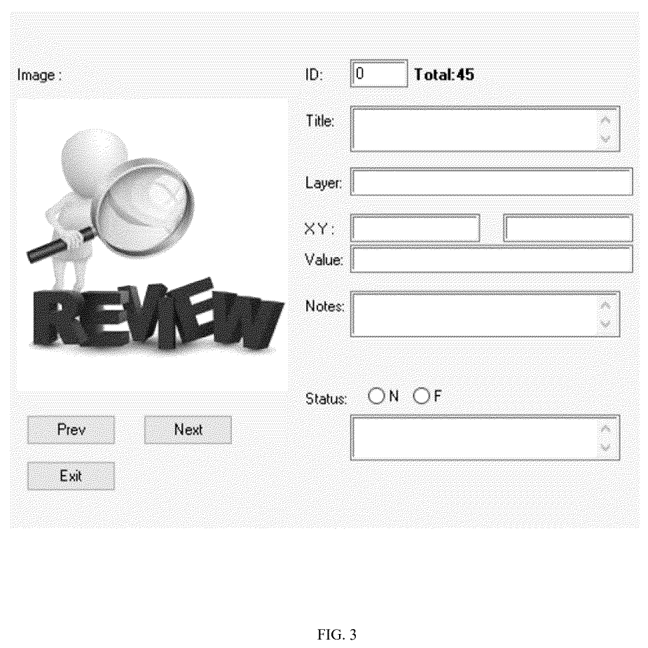

In some embodiments of the present application, as shown in FIG. 3, the first interface includes a first area and a second area, the first area is used to display the content of the problem (e.g., a number, problem information, etc.), and the second area is used to display an image of the problem.

In some embodiments of the present application, the first area includes an identifier input box (e.g., an “ID” box shown in FIG. 3) and an information display area. The identifier input box is used to display the identifier of the problem, and the user may enter an identifier corresponding to a problem to be reviewed through the “ID” box. The information display area is used to display problem information of the problem.

Block S12, the electronic device receives an identifier input by a user from the identifier input box, determines a target identifier from identifiers corresponding to at least one problem according to the identifier input by the user, and determines problem information corresponding to the target identifier as target problem information, and determines a problem image corresponding to the target identifier as a target problem image.

Specifically, the electronic device 10 determines the target identifier and the target problem information and the target problem image corresponding to the target identifier from the report data according to the identifier input by the user, where the target identifier is the same as the identifier input by the user.

Block S13, the electronic device displays the target problem information in the information display area, and displays the target problem image in the second area.

In some embodiments of the present application, the information display area includes a quantity display box (e.g., a “Total” box shown in FIG. 3), a name display box (e.g., a “Title” box shown in FIG. 3), a layer display box (e.g., “Layer” box shown in FIG. 3), a coordinate display box (e.g., a “XY” box shown in FIG. 3), and a numerical description box (e.g., a “Value” box shown in FIG. 3). Among them, the quantity display box is used to display a total number of problems in the report data. The name display box is used to display a name of the target problem. The layer display box is used to display a layer corresponding to the target problem. The coordinate display box is used to display coordinates corresponding to the target problem. The numerical description box is used to display themeasurement value of the target problem.

In the above embodiment, by analyzing the report file of the printed circuit board, the report data is obtained, where the report data includes the identifier, the problem information and the problem image corresponding to at least one problem related to the printed circuit board; the first interface including the first area and the second area is displayed, where the first area includes the identifier input box and the information display area; the identifier input by the user is received from the identifier input box, and the target identifier is determined from the identifiers corresponding to at least one problem according to the identifier input by the user, and the problem information corresponding to the target identifier is determined as the target problem information, and the problem image corresponding to the target identifier is determined as the target problem image; the target problem information is displayed in the information display area, and the target problem image is displayed in the second area. Based on this, the present application may automatically analyze the report file and extract the identifier, the problem information and the problem image corresponding to the problem, which may reduce the user's repeated manual operations, avoid the user's manual mistakes and cause audit errors, improve the audit efficiency, shorten the audit working hours, and further may quickly display the corresponding problem information and the problem image according to the identifier of the problem input by the user, without the need to check an entire report item by item, and may realize a random switching of an audit order, saving a lot of time, and further displaying the problem in a combination of the image and the text, which helps the user understand the problem more accurately, reduces misunderstandings or omissions, and improves the accuracy and reliability of the audit. By displaying the identifier of the problem, the problem information and the problem image on the first interface, the user may quickly understand details of the problem, making it easier to formulate a modification plan for the PCB design. The user may then adjust the PCB design in a timely manner to ensure that the PCB design meets the manufacturing process requirements.

In some embodiments of the present application, when switching between a Allegro board file and a Valor Check Report, it is difficult to achieve efficient linkage and positioning, which is not conducive to a designer to quickly make a targeted adjustment to the PCB design based on a feedback in the report. Based on this, the report analysis method further includes following blocks.

Block S14, the electronic device displays a second interface, determines a target problem area of the target problem in a layer corresponding to the target problem according to the layer and coordinates corresponding to the target problem, and displays the targetproblem area on the second interface.

In some embodiments of the present application, the electronic device 10 may display the second interface using an automated script, where the second interface is used to display the target problem area.

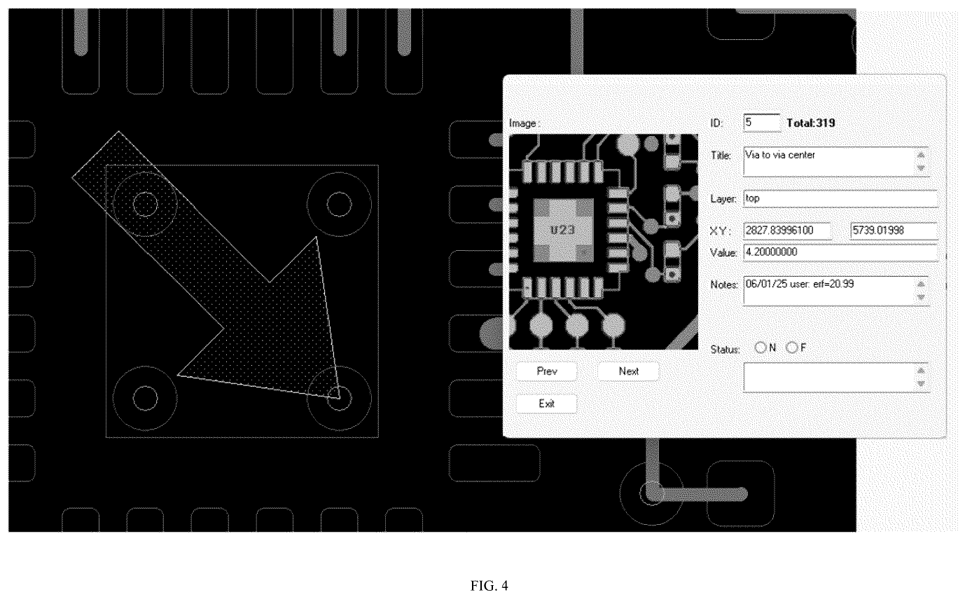

In some embodiments of the present application, in combination with FIG. 4, the electronic device 10 may automatically open relevant layers of the PCB (such as a top layer, a bottom layer, an inner layer, etc.) according to the layer corresponding to the target problem, and further display the target problem area in the layer corresponding to the target problem according to the coordinates of the target problem, that is, an enlarged image of the target problem in the corresponding layer, on the second interface.

In the above embodiment, the layer corresponding to the target problem is automatically opened according to the layer and coordinates corresponding to the target problem, and the target problem area is automatically displayed on the second interface, so that the user may have a detailed view of the target problem and formulate an accurate modification plan, thereby improving the accuracy of the review, and the user may directly adjust the PCB design to ensure that the PCB design meets the manufacturing process requirements.

Block S15, the electronic device indicates the target problem on the target problem area by a preset indicator according to the coordinates corresponding to the target problem.

In some embodiments of the present application, as shown in FIG. 4, the indicator may be an arrow, and the present application does not limit this.

In the above embodiment, the target problem on the target problem area is indicated by a preset indicator according to the coordinates corresponding to the target problem, so that the user may intuitively and quickly locate a position of the target problem without manual search or finding, which simplifies an operation process and reduces human operation errors. The user may then quickly adjust the PCB design in combination with the instructions of the indicator, thereby improving work efficiency.

In some embodiments of the present application, the report analysis method further includes following blocks.

Block S16, the electronic device receives feedback information for the target problem input by the user from a remark input box, and stores the target identifier, target problem information, the layer and the coordinates corresponding to the target problem, and feedback information of the target problem into a preset feedback file.

In some embodiments of the present application, the first area further includes the remark input box (e.g., a “Notes” box shown in FIG. 3), which is used to receive feedbackinformation input by the user, where the feedback information includes but is not limited to the user's modification of the target problem.

In the above embodiment, the electronic device 10 receives the feedback information of the target problem input by the user from the remark input box, and stores the target identifier, target problem information, target problem image, and feedback information of the target problem in the preset feedback file (e.g., a valor feedback list. csv), which enables a design team to timely understand relevant information of the PCB design, promotes a team collaboration and information sharing, and improves work efficiency.

In some embodiments of the present application, the report analysis method further includes following blocks.

Block S17, in response to a user's selection operation on processing status options, the electronic device determines a processing status of the target problem, and stores the processing status in the feedback file.

In some embodiments of the present application, in combination with FIG. 3, the first area further includes the processing status options (e.g., “Status” options “N” and “F” shown in FIG. 3). When the user selects “N”, it indicates that the processing status of the target problem is unresolved; when the user selects “F”, it indicates that the processing status of the target problem is resolved.

In other embodiments, the first area also includes a processing status description box, and after the user selects the corresponding processing status option, the user may enter relevant description information in a box below the processing status options. For example, when the user selects “N”, the unresolved reason may be entered in the box below the processing status options.

In some embodiments of the present application, when the user selects one of the processing status options, the electronic device activates a camera device of the electronic device and obtains a face image of the user using the camera device. The electronic device further verifies the user's identity based on the face image. When the user is determined to be a legal user based on the face image, the electronic device determines that the user has a right to update the processing status of the target problem. Then the electronic device determines the processing status of the target problem in response to the user's selection operation on processing status options. When the user is determined to be not the legal userbased on the face image, the electronic device transmits a message and informs the user that the user does not have right to update the processing status.

In some embodiments of the present application, the electronic device prestores a face image of each of a plurality of legal users.

In the above embodiment, by displaying the processing status option in the first area, the user may update the processing status of the target problem in real time, avoiding repeated review and ensuring that the user completes the review of each problem. The processing status is stored in the feedback file to ensure that team members may clearly understand a latest processing status of the target problem, reducing repeated communication and confirmation between team members and improving work efficiency.

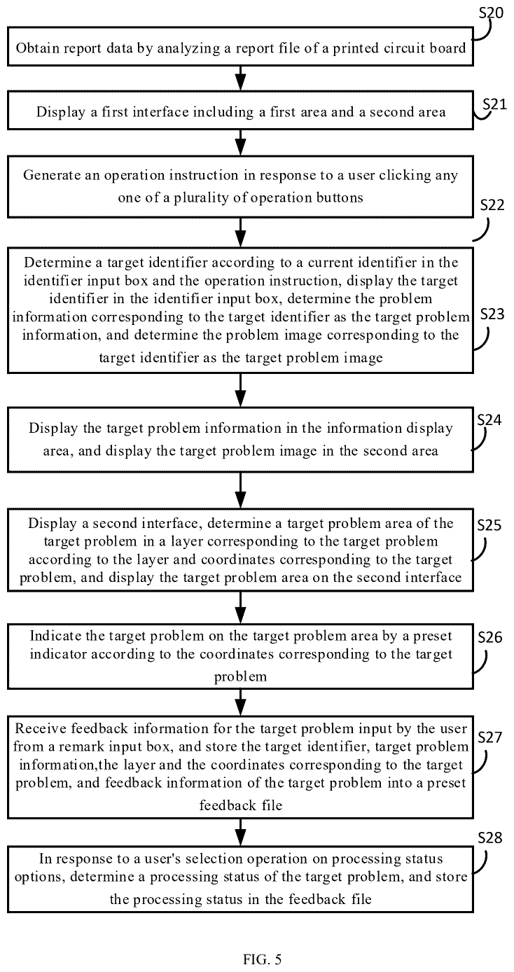

Please refer to FIG. 5, which is a flowchart of a report analysis method provided in yet another embodiment of the present application.

Specifically, the report analysis method includes the following blocks. According to different requirements, an order of some blocks in the flowchart may be changed, and some blocks may be omitted.

Block S20, the electronic device obtains report data by analyzing a report file of a printed circuit board.

In some embodiments of the present application, an automated script for automatically analyzing the report file is pre-stored in the electronic device 10. Before analyzing the report file of the printed circuit board, the electronic device 10 runs the automated script in advance and selects a report file to be analyzed. The automated script is further used to read the report file to extract the report data in the report file.

In some embodiments of the present application, the report file of the PCB refers to a DFM inspection report generated by an audit software “Valor”, which is used to detect potential problems in the PCB design. Content included in the report file includes but is not limited to an identifier (ID), a title, a status, a priority, an image, coordinates (X, Y), a measurement value, a number of layers, a reference designator (Refdes), and a last discussion of each problem.

In some embodiments of the present application, the report data includes an identifier, problem information (such as a name, coordinates, a layer) and a problem image corresponding to at least one problem related to the PCB, where the problem information corresponding to each problem includes the layer and coordinates corresponding to each problem.

Block S21, the electronic device displays a first interface including a first area and a second area.

In some embodiments of the present application, the electronic device 10 may display the first interface using an automated script.

In some embodiments of the present application, as shown in FIG. 3, the first interface includes a first area and a second area, the first area is used to display the content of the problem (e.g., a number, problem information, etc.), and the second area is used to display an image of the problem.

In some embodiments of the present application, the first area includes an identifier input box (e.g., an “ID” box shown in FIG. 3) and an information display area. The identifier input box is used to display the identifier of the problem. The information display area is used to display the problem information of the problem.

Block S22, the electronic device generates an operation instruction in response to a click on any one of a plurality of operation buttons.

In some embodiments of the present application, the first area also includes the plurality of operation buttons. As shown in FIG. 3, the plurality of operation buttons include but are not limited to a “Prev” operation button and a “Next” operation button. When the user clicks the “Prev” operation button, it indicates that the user wants to return to a previous problem, and then an operation instruction for returning to the previous problem is generated; when the user clicks the “Next” operation button, it indicates that the user wants to switch to a next problem, and an operation instruction for turning to the next problem is generated.

In other embodiments, the plurality of operation buttons further include an “Exit” operation button. When the user clicks the “Exit” operation button, it indicates that the user wants to exit a current review, and an operation instruction for exiting review is generated.

Block S23, the electronic device determines a target identifier according to a current identifier in the identifier input box and the operation instruction, displays the target identifier in the identifier input box, determines the problem information corresponding to the target identifier as the target problem information, and determines the problem image corresponding to the target identifier as the target problem image.

For example, if the operation instruction is the operation instruction for returning to the previous problem, and the current identifier in the identifier input box is 3, then the target identifier is 2; if the operation instruction is the operation instruction for turning to the next problem, the current identifier in the identifier input box is 3, then the target identifier is 4. The electronic device can delete the current identifier from the identifier input box, anddisplay the target identifier in the identifier input box.

Block S24, the electronic device displays the target problem information in the information display area, and displays the target problem image in the second area.

In some embodiments of the present application, the information display area includes a quantity display box (e.g., a “Total” box shown in FIG. 3), a name display box (e.g., a “Title” box shown in FIG. 3), a layer display box (e.g., “Layer” box shown in FIG. 3), a coordinate display box (e.g., a “XY” box shown in FIG. 3), and a numerical description box (e.g., a “Value” box shown in FIG. 3). Among them, the quantity display box is used to display a total number of problems in the report data. The name display box is used to display a name of the target problem. The layer display box is used to display a layer corresponding to the target problem. The coordinate display box is used to display coordinates corresponding to the target problem. The numerical description box is used to display the measurement value of the target problem.

In the above embodiment, by analyzing the report file of the printed circuit board, the report data is obtained, where the report data includes the identifier, the problem information and the problem image corresponding to at least one problem related to the printed circuit board; the first interface including the first area and the second area is displayed, where the first area includes the identifier input box and the information display area; an operation instruction is generated in response to a click on any one operation button of a plurality of operation buttons; a target identifier is determined according to a current identifier in the identifier input box and the operation instruction, and the target identifier is displayed in the identifier input box,

and the problem information corresponding to the target identifier is determined as the target problem information, and the problem image corresponding to the target identifier is determined as the target problem image; the target problem information is displayed in the information display area, and the target problem image is displayed in the second area. Based on this, the present application may automatically analyze the report file and extract the identifier, the problem information and the problem image corresponding to the problem, which may reduce the user's repeated manual operations, avoid the user's manual mistakes and cause audit errors, improve the audit efficiency, shorten the audit working hours, and further may quickly display the corresponding problem information and the problem image according to the identifier of the problem input by the user, without the need to check an entire report item by item, and may realize a random switching of an audit order, saving a lot of time, and further displaying the problem in a combination of the imageand the text, which helps the user understand the problem more accurately, reduces misunderstandings or omissions, and improves the accuracy and reliability of the audit. By displaying the identifier of the problem, the problem information and the problem image on the first interface, the user may quickly understand details of the problem, making it easier to formulate a modification plan for the PCB design. The user may then adjust the PCB design in a timely manner to ensure that the PCB design meets the manufacturing process requirements.

In some embodiments of the present application, the report analysis method further includes following blocks.

Block S25, the electronic device displays a second interface, determines a target problem area of the target problem in a layer corresponding to the target problem according to the layer and coordinates corresponding to the target problem, and displays the target problem area on the second interface.

In some embodiments of the present application, the electronic device 10 may display the second interface using an automated script, where the second interface is used to display the target problem area.

In some embodiments of the present application, in combination with FIG. 4, the electronic device 10 may automatically open relevant layers of the PCB (such as a top layer, a bottom layer, an inner layer, etc.) according to the layer corresponding to the target problem, and further display the target problem area in the layer corresponding to the target problem according to the coordinates of the target problem, that is, an enlarged image of the target problem in the corresponding layer, on the second interface.

In the above embodiment, the layer corresponding to the target problem is automatically opened according to the layer and coordinates corresponding to the target problem, and the target problem area is automatically displayed on the second interface, so that the user may have a detailed view of the target problem and formulate an accurate modification plan, thereby improving the accuracy of the review, and the user may directly adjust the PCB design to ensure that the PCB design meets the manufacturing process requirements.

In some embodiments of the present application, the report analysis method further includes:

Block S26, the electronic device indicates the target problem on the target problem area by a preset indicator according to the coordinates corresponding to the target problem.

In some embodiments of the present application, as shown in FIG. 4, the indicator may be an arrow, and the present application does not limit this.

In the above embodiment, the target problem on the target problem area is indicated by a preset indicator according to the coordinates corresponding to the target problem, so that the user may intuitively and quickly locate a position of the target problem without manual search or finding, which simplifies an operation process and reduces human operation errors. The user may then quickly adjust the PCB design in combination with the instructions of the indicator, thereby improving work efficiency.

In some embodiments of the present application, the report analysis method further includes following blocks.

Block S27, the electronic device receives feedback information for the target problem input by the user from a remark input box, and stores the target identifier, target problem information, the layer and the coordinates corresponding to the target problem, and feedback information of the target problem into a preset feedback file.

In some embodiments of the present application, the first area further includes the remark input box (e.g., a “Notes” box shown in FIG. 3), which is used to receive feedback information input by the user, where the feedback information includes but is not limited to the user's modification of the target problem.

In the above embodiment, the electronic device 10 receives the feedback information of the target problem input by the user from the remark input box, and stores the target identifier, target problem information, target problem image, and feedback information of the target problem in the preset feedback file (e.g., a valor feedback list. csv), which enables a design team to timely understand relevant information of the PCB design, promotes a team collaboration and information sharing, and improves work efficiency.

In some embodiments of the present application, the report analysis method further includes following blocks.

Block S28, in response to a user's selection operation on processing status options, the electronic device determines a processing status of the target problem, and stores the processing status in the feedback file.

In some embodiments of the present application, in combination with FIG. 3, the first area further includes the processing status options (e.g., “Status” options “N” and “F” shown in FIG. 3). When the user selects “N”, it indicates that the processing status of the target problem is unresolved; when the user selects “F”, it indicates that the processing status of the target problem is resolved.

In other embodiments, the first area also includes a processing status description box, and after the user selects the corresponding processing status option, the user may enter relevant description information in a box below the processing status options. For example,when the user selects “N”, the unresolved reason may be entered in the box below the processing status options.

In the above embodiment, by displaying the processing status option in the first area, the user may update the processing status of the target problem in real time, avoiding repeated review and ensuring that the user completes the review of each problem. The processing status is stored in the feedback file to ensure that team members may clearly understand a latest processing status of the target problem, reducing repeated communication and confirmation between team members and improving work efficiency.

In some embodiments of the present application, the report analysis method also includes: if the operation instruction is the operation instruction for returning to the previous problem, the electronic device 10 may mark the identifier input box with a first preset color (such as red), thereby reminding the user that the current target problem is a problem that has been reviewed.

In some embodiments of the present application, the report data includes N problems, and the report analysis method further includes: if the target identifier is the identifier of a Nth problem in the report data, the identifier input box is marked with a second preset color (for example, green), and a preset prompt box is displayed, where the prompt box is used to prompt the user that the analyzing of the report file has been completed, thereby reminding the user that the current target problem is a last problem in the report file.

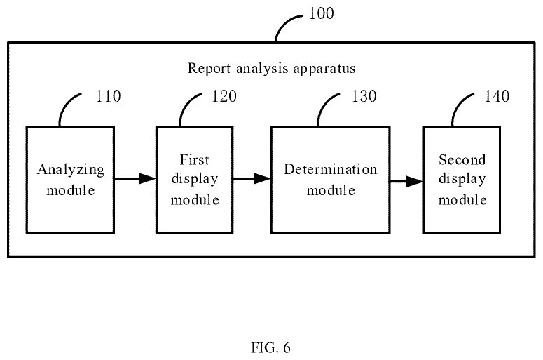

Please refer to FIG. 6, which is a schematic diagram of functional modules of a report analysis apparatus 100 provided in an embodiment of the present application.

In this embodiment, based on the same concept as the report analysis method in the embodiment shown in FIG. 3 above, the present application also provides a report analysis apparatus 100, which may be used to perform the above report analysis method. For ease of explanation, the composition diagram of the embodiment of the report analysis apparatus 100 only shows the parts related to the embodiment of the present application. Those skilled in the art may understand that the illustrated structure does not constitute a limitation on the report analysis apparatus 100, and may include more or fewer components than shown in the diagram, or combine certain components, or arrange the components differently.

Specifically, the report analysis apparatus 100 provided in the embodiment of the present application includes an analyzing module 110, a first display module 120, a determination module 130, and a second display module 140.

The analyzing module 110 is used to obtain report data by analyzing a report file of a printed circuit board.

In some embodiments of the present application, an automated script for automatically analyzing the report file is pre-stored in the electronic device 10. Before analyzing the report file of the printed circuit board, the electronic device 10 runs the automated script in advance and selects a report file to be analyzed. The automated script is further used to automatically read the report file to extract the report data in the report file.

It should be noted that the present application implements the function of the automated script through a SKILL language secondary developed and provided within a Cadence software. The SKILL language is a powerful programming language that may be used for simple tasks as well as for developing complex applications. It may interact with a underlying system and provides an interface to access interfaces of various tools in the Cadence software. Designers may use the SKILL language to access resources of a Cadence platform and develop automated scripts based on it. By writing a corresponding SKIL script, a function of automatically reading the report file is realized, allowing designers to load and view the report file directly in an environment of the Cadence software, thereby closely integrating a DFM analysis result with a PCB design, improving an efficiency and a quality of a design, ensuring that the design meets the production requirements in terms of manufacturability, and reducing potential problems and costs in subsequent production links.

In some embodiments of the present application, the report file of the PCB refers to a DFM inspection report generated by an audit software “Valor”, which is used to detect potential problems in the PCB design. Content included in the report file includes but is not limited to an identifier (ID), a title, a status, a priority, an image, coordinates (X, Y), a measurement value, a number of layers, a reference designator (Refdes), and a last discussion of each problem.

In some embodiments of the present application, the report data includes an identifier, problem information (such as a name, coordinates, a layer) and a problem image corresponding to at least one problem related to the PCB, where the problem information corresponding to each problem includes the layer and coordinates corresponding to each problem.

The first display module 120 is used to display a first interface including a first area and a second area.

In some embodiments of the present application, the electronic device 10 may display the first interface using an automated script.

In some embodiments of the present application, as shown in FIG. 3, the first interface includes a first area and a second area, the first area is used to display the content of the problem (e.g., a number, problem information, etc.), and the second area is used todisplay an image of the problem.

In some embodiments of the present application, the first area includes an identifier input box (e.g., an “ID” box shown in FIG. 3) and an information display area. The identifier input box is used to display the identifier of the problem, and the user may enter an identifier corresponding to a problem to be reviewed through the ID box. The information display area is used to display problem information of the problem.

The determination module 130 is used to receive an identifier input by a user from the identifier input box, determines a target identifier from identifiers corresponding to at least one problem according to the identifier input by the user, and determines problem information corresponding to the target identifier as target problem information, and determines a problem image corresponding to the target identifier as a target problem image.

Specifically, the electronic device 10 determines the target identifier and the target problem information and the target problem image corresponding to the target identifier from the report data according to the identifier input by the user, where the target identifier is the same as the identifier input by the user.

The second display module 140 is used to display the target problem information in the information display area, and displays the target problem image in the second area.

In some embodiments of the present application, the information display area includes a quantity display box (e.g., a “Total” box shown in FIG. 3), a name display box (e.g., a “Title” box shown in FIG. 3), a layer display box (e.g., “Layer” box shown in FIG. 3), a coordinate display box (e.g., a “XY” box shown in FIG. 3), and a numerical description box (e.g., a “Value” box shown in FIG. 3). Among them, the quantity display box is used to display a total number of problems in the report data. The name display box is used to display a name of the target problem. The layer display box is used to display a layer corresponding to the target problem. The coordinate display box is used to display coordinates corresponding to the target problem. The numerical description box is used to display the measurement value of the target problem.

In the above embodiment, by analyzing the report file of the printed circuit board, the report data is obtained, where the report data includes the identifier, the problem information and the problem image corresponding to at least one problem related to the printed circuit board; the first interface including the first area and the second area is displayed, where the first area includes the identifier input box and the information display area; the identifier input by the user is received from the identifier input box, and the target identifier is determined from the identifiers corresponding to at least one problem according to the identifier input by the user, and the problem information corresponding to the targetidentifier is determined as the target problem information, and the problem image corresponding to the target identifier is determined as the target problem image; the target problem information is displayed in the information display area, and the target problem image is displayed in the second area. Based on this, the present application may automatically analyze the report file and extract the identifier, the problem information and the problem image corresponding to the problem, which may reduce the user's repeated manual operations, avoid the user's manual mistakes and cause audit errors, improve the audit efficiency, shorten the audit working hours, and further may quickly display the corresponding problem information and the problem image according to the identifier of the problem input by the user, without the need to check an entire report item by item, and may realize a random switching of an audit order, saving a lot of time, and further displaying the problem in a combination of the image and the text, which helps the user understand the problem more accurately, reduces misunderstandings or omissions, and improves the accuracy and reliability of the audit. By displaying the identifier of the problem, the problem information and the problem image on the first interface, the user may quickly understand details of the problem, making it easier to formulate a modification plan for the PCB design. The user may then adjust the PCB design in a timely manner to ensure that the PCB design meets the manufacturing process requirements.

As shown in FIG. 1, in some embodiments of the present application, the electronic device 10 includes, but is not limited to, a storage device 11, a processor 12, and a computer program, such as a report analysis program stored in the storage device 11 and executable on the processor 12. When the computer program is executed by the processor, the report analysis method of the above-mentioned embodiment is implemented.

FIG. 1 only shows the electronic device 10 having a storage device 11 and a processor 12. Those skilled in the art may appreciate that the structure shown in FIG. 1 does not limit the electronic device 10 and may include fewer or more components than shown, or a combination of certain components, or a different arrangement of components.

The storage device 11 in the electronic device 10 stores computer-readable instructions to implement the report analysis method, and the processor 12 may execute the instructions to: analyze a report file of a printed circuit board to obtain report data, where the report data includes an identifier, problem information, and a problem image of at least one problem related to the printed circuit board; display a first interface including a first area and a second area, where the first area includes an identifier input box and an information display area; receive an identifier input by a user from the identifier input box, determine a target identifier from identifiers corresponding to at least one problem according to theidentifier input by the user, and determine the problem information corresponding to the target identifier as target problem information, and determine the problem image corresponding to the target identifier as a target problem image; display the target problem information in the information display area, and display the target problem image in the second area.

Specifically, a specific implementation method of the processor 12 for the above instructions may refer to the description of the relevant blocks in the corresponding embodiments of FIG. 2 and FIG. 5, which will not be repeated here.

Those skilled in the art will appreciate that the schematic diagram is merely an example of the electronic device 10 and does not constitute a limitation on the electronic device 10. The electronic device 10 may be a bus-type structure or a star-type structure. The electronic device 10 may also include more or less other hardware or software than shown in the figure, or a different arrangement of components. For example, the electronic device 10 may also include input and output devices, network access devices, etc.

It should be noted that the electronic device 10 is only an example, and other existing or future electronic products that are suitable for the present application should also be included in the protection scope of the present application and included here by reference.

Among them, the storage device 11 includes at least one type of computer-readable storage medium, and the computer-readable storage medium may be non-volatile storage medium or volatile storage medium. Computer-readable storage medium include a flash memory, a mobile hard disk, a multimedia card, a card-type storage device (such as a SD storage device, a DX storage device, etc.), a magnetic memory, disk, an optical disk, etc. In some embodiments, the storage device 11 may be an internal storage unit of the electronic device 10, such as a mobile hard disk of the electronic device 10. In other embodiments, the storage device 11 may also be an external storage device of the electronic device 10, such as a plug-in mobile hard disk, a smart memory card (SMC), a secure digital (SD) card, a flash card, etc. equipped on the electronic device 10. The storage device 11 may not only be used to store application software and various types of data installed in the electronic device 10, such as a code of a report analysis program, etc., but also may be used to temporarily store data that has been output or is to be output.

In some embodiments, the processor 12 may be composed of an integrated circuit, for example, a single packaged integrated circuit, or a plurality of packaged integrated circuits with the same or different functions, including one or more central processing units (CPUs), microprocessors, digital processing chips, graphics processors, and combinations of various control chips. The processor 12 is a control core (control unit) of the electronicdevice 10, and uses various interfaces and lines to connect various components of the entire electronic device 10, and executes various functions and processes data of the electronic device 10 by running or executing programs or modules stored in the storage device 11 (for example, executing a report analysis program, etc.), and calling data stored in the storage device 11.

The processor 12 executes the operating system and various installed application programs of the electronic device 10. The processor 12 executes the application programs to implement the blocks in each of the above-mentioned report analysis method embodiments.

Exemplarily, the computer program may be divided into one or more modules/units, one or more modules/units are stored in the storage device 11, and executed by the processor 12 to complete the present application. One or more modules/units may be a series of computer-readable instruction segments capable of completing specific functions, and the instruction segments are used to describe the execution process of the computer program in the electronic device 10.

The above-mentioned integrated unit implemented in the form of a software function module may be stored in a computer-readable storage medium. The above-mentioned software function module is stored in a storage medium, including a number of instructions for enabling a computer device (which may be a personal computer, a computer device or a network device, etc.) or a processor 12 to execute a part of a report analysis method of each embodiment of the present application.

If the module/unit integrated in the electronic device 10 is implemented in the form of a software functional unit and sold or used as an independent product, it may be stored in a computer-readable storage medium. Based on this understanding, the present application implements all or part of the processes in the above-mentioned embodiment method, and may also instruct the relevant hardware devices to complete through a computer program. The computer program may be stored in a computer-readable storage medium, and when the computer program is executed by the processor 12, the blocks of the above-mentioned various method embodiments may be implemented.

The computer program includes computer program code, which may be in source code form, object code form, executable file or some intermediate form, etc. Computer readable media may include: any entity or device capable of carrying computer program code, recording medium, USB flash drive, mobile hard disk, magnetic disk, optical disk, computer memory, read-only memory (ROM), random access memory and other memory, etc.

Furthermore, the computer-readable storage medium may mainly include aprogram storage area and a data storage area, wherein the program storage area may store an operating system, an application required for at least one function, etc. ; the data storage area may store data created according to the use of the blockchain node, etc.

The bus may be a Peripheral Component Interconnect (PCI) bus or an Extended Industry Standard Architecture (EISA) bus, etc. The bus may be divided into an address bus, a data bus, a control bus, etc. For ease of representation, only one arrow is used in FIG. 1, but it does not mean that there is only one bus or one type of bus. The bus is configured to realize connection and communication between the storage device 11 and at least one processor 12, etc.

embodiment of the present application also provides a computer-readable storage medium (not shown), in which computer-readable storage medium is stored computer-readable instructions, and the computer-readable instructions are executed by the processor 12 in the electronic device 10 to implement a report analysis method of any of the above embodiments.

In the several embodiments provided in the present application, it should be understood that the disclosed systems, devices and methods may be implemented in other ways. For example, the device embodiments described above are only schematic, for example, the division of modules is only a logical function division, and there may be other division methods in actual implementation.

The modules described as separate components may or may not be physically separated, and the components shown as modules may or may not be physical units, that is, they may be located in one place or distributed on multiple network units. Some or all of the modules may be selected according to actual needs to achieve the purpose of the solution of this embodiment.

In addition, each functional module in each embodiment of the present application may be integrated into one processing unit, or each unit may exist physically separately, or two or more units may be integrated into one unit. The above integrated unit may be implemented in the form of hardware or in the form of hardware plus software functional modules.

In addition, it is obvious that the word “comprising” does not exclude other units or steps, and the singular does not exclude the plural. Multiple units or devices stated in the specification may also be implemented by one unit or device through software or hardware. The words first, second, etc. are used to indicate names, and do not indicate any specific order.

Finally, it should be noted that the above embodiments are only used to illustratethe technical solution of the present application and are not intended to limit it. Although the present application has been described in detail with reference to the preferred embodiments, a person of ordinary skill in the art should understand that the technical solution of the present application may be modified or replaced by equivalents without departing from the spirit and scope of the technical solution of the present application.

What is claimed is:

1. A report analysis method, comprising:
obtaining report data by analyzing a report file of a printed circuit board, the report data comprising an identifier, problem information, and a problem image corresponding to each problem related to the printed circuit board;
displaying a first interface comprising a first area and a second area, the first area comprising an identifier input box and an information display area;
receiving an identifier from the identifier input box, determining a target identifier from identifiers corresponding to the at least one problem according to the identifier, determining problem information corresponding to the target identifier as target problem information, and determining a problem image corresponding to the target identifier as target problem image; and
displaying the target problem information in the information display area, and displaying the target problem image in the second area.

2. The report analysis method according to claim 1, wherein the problem information corresponding to each problem comprises a layer and coordinates, and after displaying the target problem image in the second area, the method further comprises:
displaying a second interface, determining a target problem area of the target problem in a layer corresponding to the target problem according to the coordinates corresponding to the target problem, and displaying the target problem area on the second interface.

3. The report analysis method according to claim 2, wherein after displaying the target problem area on the second interface, the method further comprises:
indicating the target problem on the target problem area by a preset indicator according to the coordinates corresponding to the target problem.

4. The report analysis method according to claim 3, wherein the first area further comprises a remark input box, and after indicating the target problem on the target problem area by the preset indicator, the method further comprises:
receiving feedback information for the target problem from the remark input box, and storing the target identifier, the target problem information, the layer and the coordinates corresponding to the target problem, and the feedback information of the target problem into a preset feedback file.

5. The report analysis method according to claim 4, wherein the first area further comprises processing status options, and after displaying the target problem area on the second interface, the method further comprises:
in response to a selection operation of the processing status options, determining a processingstatus of the target problem and storing the processing status of the target problem in the preset feedback file, wherein the processing status comprises a resolved status or a unresolved status.

6. The report analysis method according to claim 1, wherein the first area further comprises a plurality of operation buttons, and after displaying the first interface, the method further comprises:
generating an operation instruction in response to a click on any one operation button of the plurality of operation buttons;
determining the target identifier according to a current identifier in the identifier input box and the operation instruction, and displaying the target identifier in the identifier input box.

7. The report analysis method according to claim 6, wherein after displaying the target identifier in the identifier input box, the method further comprises:
in response that the operation instruction is an operation instruction for returning to a previous problem, marking the identifier input box with a first preset color.

8. The report analysis method according to claim 1, wherein the report data comprises N problems, where N is a positive integer greater than 0, and the method further comprises:
in response that the target identifier is an identifier of a Nth problem in the report data, marking the identifier input box with a second preset color, and displaying a preset prompt box for indicating the user that an analysis of the report file has been completed.

9. An electronic device, comprising:
a storage device storing a computer program;
a processor, when the at least one instruction is executed by the at least one processor, the at least one processor is caused to:
obtain report data by analyzing a report file of a printed circuit board, the report data comprising an identifier, problem information, and a problem image corresponding to each problem related to the printed circuit board;
display a first interface comprising a first area and a second area, the first area comprising an identifier input box and an information display area;
receive an identifier from the identifier input box, determine a target identifier from identifiers corresponding to the at least one problem according to the identifier, determine problem information corresponding to the target identifier as target problem information, and determine a problem image corresponding to the target identifier as target problem image; and
display the target problem information in the information display area, and display the target problem image in the second area.

10. The electronic device according to claim 9, wherein the problem information corresponding to each problem comprises a layer and coordinates, and after displaying the target problem image in the second area, the at least one processor is further caused to:
display a second interface, determine a target problem area of the target problem in a layer corresponding to the target problem according to the coordinates corresponding to the target problem, and display the target problem area on the second interface.

11. The electronic device according to claim 10, wherein after displaying the target problem area on the second interface, the at least one processor is further caused to:
indicate the target problem on the target problem area by a preset indicator according to the coordinates corresponding to the target problem.

12. The electronic device according to claim 11, wherein the first area further comprises a remark input box, and after indicating the target problem on the target problem area by the preset indicator, the at least one processor is further caused to:
receive feedback information for the target problem from the remark input box, and store the target identifier, the target problem information, the layer and the coordinates corresponding to the target problem, and the feedback information of the target problem into a preset feedback file.

13. The electronic device according to claim 12, wherein the first area further comprises processing status options, and after displaying the target problem area on the second interface, the method further comprises:
in response to a selection operation of the processing status options, determine a processing status of the target problem and store the processing status of the target problem in the preset feedback file, wherein the processing status comprises a resolved status or a unresolved status.

14. The electronic device according to claim 9, wherein the first area further comprises a plurality of operation buttons, and after displaying the first interface, the at least one processor is further caused to:
generate an operation instruction in response to a click on any one operation button of the plurality of operation buttons;
determine the target identifier according to a current identifier in the identifier input box and the operation instruction, and display the target identifier in the identifier input box.

15. The electronic device according to claim 14, wherein after displaying the target identifier in the identifier input box, the at least one processor is further caused to:
in response that the operation instruction is an operation instruction for returning to a previous problem, mark the identifier input box with a first preset color.

16. The electronic device according to claim 15, wherein the report data comprises N problems, where N is a positive integer greater than 0, and the at least one processor is further caused to:
in response that the target identifier is an identifier of a Nth problem in the report data,mark the identifier input box with a second preset color, and display a preset prompt box for indicating the user that an analysis of the report file has been completed.

17. A non-transitory storage medium, stored with a computer program, which when executed by a processor, causing the processor performs a report analysis method, wherein the method comprises:
obtaining report data by analyzing a report file of a printed circuit board, the report data comprising an identifier, problem information, and a problem image corresponding to each problem related to the printed circuit board;
displaying a first interface comprising a first area and a second area, the first area comprising an identifier input box and an information display area;
receiving an identifier from the identifier input box, determining a target identifier from identifiers corresponding to the at least one problem according to the identifier, determining problem information corresponding to the target identifier as target problem information, and determining a problem image corresponding to the target identifier as target problem image; and
displaying the target problem information in the information display area, and displaying the target problem image in the second area.

18. The non-transitory storage medium according to claim 17, wherein the problem information corresponding to each problem comprises a layer and coordinates, and after displaying the target problem image in the second area, the method further comprises:
displaying a second interface, determining a target problem area of the target problem in a layer corresponding to the target problem according to the coordinates corresponding to the target problem, and displaying the target problem area on the second interface.

19. The non-transitory storage medium according to claim 18, wherein after displaying the target problem area on the second interface, the method further comprises:
indicating the target problem on the target problem area by a preset indicator according to the coordinates corresponding to the target problem.

20. The non-transitory storage medium according to claim 19, wherein the first area further comprises a remark input box, and after indicating the target problem on the target problem area by the preset indicator, the method further comprises:
receiving feedback information for the target problem from the remark input box, and storing the target identifier, the target problem information, the layer and the coordinates corresponding to the target problem, and the feedback information of the target problem into a preset feedback fi
